(19) United States
(12) Patent Application Publication
(10) Pub. No.: US 2005/0068883 A1
(43) Pub. Date: Mar. 31, 2005

(54) Optical recording medium and method for production of optical recording medium

(75) Inventors: Atsushi Kondo, Koufu-shi (JP); Toshihiko Takishita, Koufu-shi (JP); Seiro Oshima, Koufu-shi (JP); Takao Tagiri, Koufu-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/948,461

(22) Filed: Sep. 24, 2004

(30) Foreign Application Priority Data
Sep. 30, 2003 (JP) P2003-341593
Sep. 30, 2003 (JP) P2003-341594
Oct. 2, 2003 (JP) P2003-344627
Oct. 3, 2003 (JP) P2003-346043

(51) Int. Cl. G11B 7/24

(52) U.S. Cl. 369/288; 369/275.4

(57) ABSTRACT

An optical recording medium having a structure comprising at least a first substrate, a first recording layer capable of optical recording, a first reflection layer, an intermediate layer, a second recording layer capable of optical recording, a second reflection layer and a second substrate in this order from a side on which recording, reproducing or recording and reproducing laser light is applied, wherein the intermediate layer is composed of a resin having a glass transition temperature of 90° C. or greater.

### BACKGROUND OF THE INVENTION

1. Field of the Invention

This application relates to an optical recording medium and a method for production of the optical recording medium. Specifically, this application relates to improvement of playback signal of characteristics of signals recorded in layers, and the like in a two-layer structure writing optical recording medium. This application relates to improvement of reflection coefficients, and the like in layers in a two-layer structure writing optical recording medium.

2. Related Art

Optical recording media such as DVDs (digital versatile discs) have been known as recording media recording and reproducing various kinds of information. For such optical recording media, single layer type optical recording media each having one layer in which information is recorded from one face side, and dual layer type optical recording media each having two layers in which information is recorded from one face side are known.

Of these optical recording media, the dual layer type optical recording medium has two layers in which information is recorded (hereinafter referred to simply as recording layers), and therefore a large volume of information can be recorded at a high density and reproduced. For the dual layer type optical recording medium, information can be recorded on two recording layers from one face side, and therefore it is not necessary to provide optical pickups on each face side on which the optical recording medium is placed and switch between the optical pickups in a recording/reproducing apparatus for the optical recording medium. The dual layer type optical recording medium doe not require inversion of the optical recording medium during recording/reproducing. Thus, the dual layer type optical recording medium enables so called seamless recording and seamless reproduction.

In this way, the dual layer type optical recording medium has advantages that it has an excellent information recording capability, a configuration of the recording/reproducing apparatus for the optical recording medium is simple, video appreciation or the like by a user is never interrupted for seamless recording/reproducing, and the like.

For such DVDs, those capable of recording information, so called DVD-R and DVD-RAM have been developed.

A basic configuration of DVD-R is showed hereinafter. (1) At first, pregrooves composed of spiral grooves, which is tracked by the optical pickup, are formed in an information recording area on a surface of a disc. (2) Then, a recording medium composed of an organic pigment and the like is coated on the regrooves by a method such as a spin coating method, and dried to form a recording layer. (3) And a reflection layer composed of a metal film is formed on the recording layer.

For example, dual layer type DVD-R type optical recording media are disclosed in patent document 1 (Japanese Laid-Open patent application no. 11-66622), etc. Specifically, as shown in FIG. 1, an optical recording medium 6 formed by bonding together using an adhesive 5B or the like a first disc having a first recording layer 21B composed of an organic pigment and a semi-transparent first reflection layer 31B formed on a first substrate 11B on a side on which grooves are formed and a second disc having a second reflection layer 32B and a second recording layer 22B composed of an organic pigment formed on a second substrate 12B on a side on which grooves are formed, with the first reflection layer 31B opposed to the second recording layer 22B.

In this optical recording medium 6, laser light is applied from the first substrate 11B side to record information in recording layers 21B and 22B.

### SUMMARY OF THE INVENTION

In such a dual layer type optical recording medium, improvements in characteristics in recording/reproducing are desired.

Thus, this application has as an example of a first object the provision of an optical recording medium having improved characteristics in recording/reproducing.

The dual layer type DVD-R type optical recording medium described above enables information to be recorded and reproduced for two recording layers from one substrate side, and therefore can record and reproduce a larger volume of information compared to the conventional single layer DVD-R type optical recording medium.

However, compatibility should be maintained with dual layer type DVD-ROM for disseminating such dual layer type DVD-R type optical media to a larger number of users as large capacity recording media. Studies have been conducted on this respect, but this technique has not been established yet.

Thus, this application has as an example of a second object the provision of an improved optical medium and a method for production of the same. This application has an example of another object the provision of an optical recording medium such that a reflection coefficient in each layer is improved to a predetermined value or greater, and compatibility is maintained with a ROM type optical recording medium in a two layer structure writing optical recording medium.

In the dual layer type optical medium described above, recording layers 21B and 22B are composed of organic pigments, and therefore when information is recorded in the recording layers 21B and 22B, a refraction index decreases in a pit portion in which the information is recorded. For example, the organic pigments of recording layers 21B and 22B each have a refraction index n of about 2.3. And after recording of information, the refraction index of the organic pigments decrease to about 2.

In this case, the first recording layer 21B at a position of grooves G1B and the second recording layer 22B at a position of grooves G2B are different in phase structure seen from the first substrate 11B side. Therefore, if information is recorded in the grooves G1B of the first recording layer 21B, an optical depth of a pit portion in the grooves G1B increases due to the decrease in refraction index. On the other hand, if information is recorded in the grooves G2B of the second recording layer 22B, an optical depth of a pit portion in the grooves G2B decreases due to the decrease in refraction index.

As a result, when information recorded in the grooves G1B and G2B of the first recording layer 21B and the second recording layer 22B, respectively, is reproduced, characteristics of readable reproducing signals are uneven between the first recording layer 21B and the second recording layer 22B.

Thus, this application has as an example of a third object the provision of an improved optical recording medium and a method for production of the same. This application has as an example of another object the provision of an optical recording medium having solved the inconvenience of unevenness between characteristics of reproducing signals from two recording layers occurring in the conventional two-layer structure writing optical recording medium.

In the double side bonding type dual layer optical recording medium described above, as shown in the FIG. 1, the first recording layer 21B is formed on the first substrate 11B in such a manner as to contact the first substrate 11B. On the other hand, the second recording layer 22B is bonded to the second substrate 12B through the second reflection layer 32B, and the grooves of the second recording layer 22B are poor in capability in shape of following grooves formed in the second substrate 12B. Thus, if information is recorded in the first recording layer 21B, the optical depth of the pit increases due to a decrease in refraction index of a pigment layer in a portion of the pit in which information is recorded.

But if information is recorded in the second recording layer 22B, the optical depth is relatively small in the pit due to a decrease in refraction index of the pigment layer in a portion of the pit in which information is recorded. Accordingly, there arises a inconvenience such that unevenness occurs between characteristics of reproducing signals from two recording layers, etc.

In the double side bonding type dual layer optical recording medium described above, an adhesive 5B or the like that is used for bonding together the first disc and the second disc is applied after formation of the recording layer.

Therefore, the adhesive 5B is limited to those not dissolving the recording medium, and it is difficult to form an intermediate layer excellent in optical characteristics due to the adhesive or the like.

Thus, this application has as an example of a fourth object the provision of an improved optical recording medium and a method for production of the same. This application has as an example of another object the provision of an optical recording medium having solved the inconvenient of unevenness between characteristics of reproducing signals from two recording layers occurring in the conventional two-layer structure writing optical recording medium.

The above first object of the present invention can be achieved by an optical recording medium of the present invention. The optical recording medium having a structure comprising at least a first substrate, a first recording layer capable of optical recording, a first reflection layer, an intermediate layer, a second recording layer capable of optical recording, a second reflection layer and a second substrate in this order from a side on which recording, reproducing or recording and reproducing laser light is applied, wherein the intermediate layer is composed of a resin having a glass transition temperature of not less than 90° C.

According to the present invention, a resin having a glass transition temperature of 90° C. or greater as the material of the intermediate layer provided between the first recording layer and the second recording layer, whereby recording/reproducing characteristics of the optical recording medium are improved. Specifically, the optical recording medium allows a specific modulation degree and reflection coefficient to be obtained in the first recording layer and the second recording layer.

In one aspect of the present invention, the optical recording medium is wherein the first substrate has first pregrooves of first grooves on the first recording layer side, and the intermediate layer has second pregrooves of second grooves on the second recording layer side.

In another aspect of the present invention, the optical recording medium is wherein the intermediate layer is composed of an ultraviolet curing resin.

In further aspect of the present invention, the optical recording medium is wherein where a real part of complex refractive indexes of the first recording layer and the second recording layer is n, and an imaginary part of the complex refractive indexes is k, a requirement of k≦0.125n−0.175, 2≦n≦3 is met.

In further aspect of the present invention, the optical recording medium is wherein the first recording layer has first grooves recessed toward the first substrate side, the intermediate layer has second grooves recessed toward the first substrate side, and a depth of the second grooves is larger than a depth of the first grooves.

The above second object of the present invention can be achieved by an optical recording medium of the present invention. The optical recording medium having a structure comprising at least a first substrate, a first recording layer capable of optical recording, a first reflection layer, an intermediate layer, a second recording layer capable of optical recording, a second reflection layer and a second substrate in this order from a side on which recording, reproducing or recording and reproducing laser light is applied, wherein where a real part of complex refractive indexes of the first recording layer and the second recording layer is n, and an imaginary part of the complex refractive indexes is k, a requirement of k≦0.125n−0.175, 2≦n≦3 is met.

According to the present invention, a high reflection coefficient, i.e. 18% or greater can be obtained in each of the first recording layer and the second recording layer if reproducing or recording and reproducing laser light is applied to the recording layers in grooves from the first substrate side to reproduce information, and thus a ROM compatible writing recording medium excellent in general versatility can be provided.

In one aspect of the present invention, the optical recording medium is wherein grooves are formed in a helical or centric form on the first substrate and the intermediate layer.

In another aspect of the present invention, the optical recording medium is wherein the first substrate has first grooves on the first recording layer side, and the intermediate layer has second grooves on the second recording layer side.

In further aspect of the present invention, the optical recording medium is wherein the first recording layer has first grooves recessed toward the first substrate side, the intermediate layer has second grooves recessed toward the first substrate side, and a depth of the second grooves is larger than a depth of the first grooves.

The above second object of the present invention can be achieved by a method for production of an optical recording medium of the present invention. The method for production of an optical recording medium comprising, step of depositing a first recording layer capable of optical recording on a first substrate on one face, step of depositing a first reflection layer on the first recording layer, step of depositing an intermediate layer on the first reflection layer, step of depositing a second recording layer capable of optical recording on the intermediate layer, step of depositing a second reflection layer on the second recording layer, and step of bonding the second reflection layer and a second substrate together, wherein where a real part of complex refractive indexes of the first recording layer and the second recording layer is n, and an imaginary part of the complex refractive indexes is k, in the step of depositing the first recording layer, the first reflection layer, the second recording layer and the second reflection layer, a requirement of k≦0.125n−0.175, 2≦n≦3 is met.

According to the present invention, a structure having a high reflection coefficient, which is compatible with a ROM type optical recording medium, can easily be formed as a dual layer type optical recording medium. Since it is not necessary to form an adhesive layer at a location having influences on the organic pigment of the recording layer, there is no possibility that characteristics of the optical recording medium are degraded by the adhesive.

In one aspect of the present invention, the method for production of an optical recording medium is wherein grooves are formed in a helical or centric form on the first substrate and the intermediate layer.

In another aspect of the present invention, the method for production of an optical recording medium is wherein the first substrate has first grooves on the first recording layer side, and the intermediate layer has second grooves on the second recording layer side.

In further aspect of the present invention, the method for production of an optical recording medium is wherein the first recording layer has first grooves recessed toward the first substrate side, the intermediate layer has second grooves recessed toward the first substrate side, and a depth of the second grooves is larger than a depth of the first grooves.

The above third object of the present invention can be achieved by an optical recording medium of the present invention. The optical recording medium having a structure comprising at least a first substrate, a first recording layer capable of optical recording, a first reflection layer, an intermediate layer, a second recording layer capable of optical recording, a second reflection layer and a second substrate in this order from a side on which recording, reproducing or recording and reproducing laser light is applied, wherein the first substrate has first grooves on the first recording layer side, and the intermediate layer has second grooves on the second recording layer side.

According to the present invention, the optical recording medium has the first recording layer on the first grooves of the first substrate and has the second recording layer on the second grooves of the intermediate layer. Thus making it possible to form the each recording layers on the each grooves having similar shapes. Accordingly, the first recording layer and the second recording layer can be made to have same phase structures when seen from the first substrate side with same materials and in a same thickness. And therefore even if refractive indexes in recorded pit portions in the recording layers decrease, the recording layers have optical depths of pit portions changed equally. Thus, in the optical recording medium, characteristics of signals reproduced from the each recording layers are equalized, and thus other problems are hard to occur.

And in the optical recording medium, the first reflection layer is formed on the first recording layer, and therefore a range of selection of a material that is used for the intermediate layer formed thereon is extended. In the optical recording medium of the third embodiment, the second reflection layer is formed on the second recording layer, and therefore a range of selection of a material that is used for an adhesive layer formed thereon is extended.

In one aspect of the present invention, the optical recording medium is wherein the first reflection layer and the second reflection layer each have a flat face on the first substrate side.

In another aspect of the present invention, the optical recording medium is wherein the intermediate layer has a dielectric layer on the second grooves on the second recording layer side.

In further aspect of the present invention, the optical recording medium is wherein the intermediate layer is composed of an ultraviolet curing resin.

In further aspect of the present invention, the optical recording medium is wherein a shape of the first grooves of the first substrate and the first recording layer, and a shape of the second grooves of the intermediate layer and the second recording layer have same phase structures when seen from the first substrate side.

The above third object of the present invention can be achieved by a method for production of a method for production of an optical recording medium of the present invention. The method for production of an optical recording medium comprising, step of forming a first groove on a first substrate, step of depositing a first recording layer capable of optical recording on the first substrate on the first groove side, step of depositing a first reflection layer on the first recording layer, step of depositing an intermediate layer on the first reflection layer, step of forming a second groove on the intermediate layer on a side on which the first reflection layer is not provided, step of depositing a second recording layer capable of optical recording on the intermediate layer on the second groove side, step of depositing a second reflection layer on the second recording layer, and step of bonding the second reflection layer and a second substrate together.

According to the present invention, the optical recording medium produced by the production method has the first recording layer on the first grooves of the first substrate and has the second recording layer on the second grooves of the intermediate layer, thus making it possible to form the each recording layers on the each grooves having similar shapes. Accordingly, the first recording layer and the second recording layer can be made to have same phase structures when seen from the first substrate side with same materials and in a same thickness, and therefore even if refractive indexes in recorded pit portions in the recording layers decrease, the recording layers have optical depths of pit portions changed equally. Thus, in the produced optical recording medium, characteristics of signals reproduced from the recording layers are equalized, and thus information can be stably reproduced from the recording layers.

And in the optical recording medium, the first reflection layer is formed on the first recording layer, and therefore a range of selection of a material that is used for the intermediate layer formed thereon is extended. In the optical recording medium, the second reflection layer is formed on the second recording layer, and therefore a range of selection of a material that is used for the adhesive layer formed thereon is extended.

In one aspect of the present invention, the method for production of an optical recording medium is wherein the first reflection layer and the second reflection layer each have a flat face on the first substrate side.

In another aspect of the present invention, the method for production of an optical recording medium is wherein the intermediate layer has a dielectric layer on the second grooves on the second recording layer side.

In further aspect of the present invention, the method for production of an optical recording medium is wherein the intermediate layer is composed of an ultraviolet curing resin.

In further aspect of the present invention, the method for production of an optical recording medium is wherein a shape of the first grooves of the first substrate and the first recording layer, and a shape of the second grooves of the intermediate layer and the second recording layer have same phase structures when seen from the first substrate side.

The above fourth object of the present invention can be achieved by an optical recording medium of the present invention. The optical recording medium having a structure comprising at least a first substrate, a first recording layer capable of optical recording, a first reflection layer, an intermediate layer, a second recording layer capable of optical recording, a second reflection layer and a second substrate in this order from a side on which recording, reproducing or recording and reproducing laser light is applied, wherein the first recording layer has first grooves recessed toward the first substrate side, the second recording layer has second grooves recessed toward the first substrate side, and a depth of the second grooves is larger than a depth of the first grooves.

According to the present invention, an optical depth of a pit portion changes in the second recording layer as in the first recording layer if a refractive index of the recorded pit portion decreases when recording, reproducing or recording and reproducing laser light is applied to the recording layers in the grooves from the first substrate side to perform recording and reproducing the optical recording medium. Thus, in the optical recording medium, characteristics reproduced from the each recording layers are equalized, and information can be stably reproduced from the each recording layers.

The above fourth object of the present invention can be achieved by a method for production of an optical recording medium of the present invention. The method for production of an optical recording medium comprising, step of forming grooves at a predetermined position on one face of a first substrate, step of depositing a recording medium on the first substrate to form a first recording layer having first grooves having a shape following the grooves of the first substrate, step of depositing a first reflection layer on the first recording layer, step of depositing an intermediate layer on the first reflection layer, step of forming grooves recessed toward the first substrate side on an opposite side of the intermediate layer, step of depositing a recording medium on the intermediate layer to form a second recording layer having second grooves having a shape following the grooves of the intermediate layer, step of depositing a second reflection layer on the second recording layer, and step of depositing a second substrate on the second reflection layer, wherein the second recording layer has the second grooves having a depth larger than a depth of the first grooves.

According to the present invention, a structure comprising the second recording layer having second grooves having a depth larger than the depth of first grooves of the first recording layer can be easily be formed as a dual layer type optical recording medium. Since it is not necessary to form an adhesive layer at a location having influences on the organic pigment of the recording layer, there is no possibility that characteristics of the optical recording medium are degraded by the adhesive.

### BRIEF DESCRIPTION OF THE DRAWINGS

FIG. 1 is a sectional view of an optical recording medium of a prior art;

FIG. 2 is a sectional view vertical to a direction along a disc face of an optical recording medium of the embodiment of this application;

FIG. 3 is another sectional view vertical to the direction along the disc face of the optical recording medium of the embodiment of this application;

FIG. 4 is a graph showing a range meeting conditions in this application;

FIG. 5 is a graph showing an area in which a reflection coefficient R_{do} from a first recording layer is 18% or greater with a same structure (pigment thickness, thickness of semi-transparent film) as in Example B1;

FIG. 6 is a graph showing an area in which a same optical transmittance T_{LO} as in Example B1 with the same structure (pigment thickness, thickness of semi-transparent film) can be obtained as in Example B1;

FIG. 7 is a graph showing an area in which a reflection coefficient R_{L1} of a second recording single layer has a same value as in Example B1 when the layer has a same thickness as in Example B1; and

FIG. 8 is a graph showing a part in which three areas shown in FIGS. 5, 6 and 7 overlap.

### EXPLANATION OF SYMBOLS

Each meaning of the reference numbers in the drawings areas follows: 1, 6 an optical recording medium, 11A, 11B: a first substrate, 12A, 12B: a second substrate, 21A, 21B: a first recording layer, 22A, 22B: a second recording layer, 31A, 31B: a first reflection layer, 32A, 32B: a second reflection layer, 4: an intermediate layer, 5A, 5B: an adhesive, 61: first disc, and 62: second disc.

### DESCRIPTION OF THE PREFERRED EMBODIMENTS

(First Embodiment)

An optical recording medium of the first embodiment according to this application and a method for production of the same will be described specifically below with reference to FIG. 2.

FIG. 2 is a sectional view showing part of a cross section in a direction vertical to a disc face of the optical recording medium of the first embodiment. In FIG. 2, the thick ness of each layer is exaggerated.

The inventors of this application found that a difference in glass transition temperature of a material of an intermediate layer provided between two recording layers in the optical recording medium had influences on recording/reproducing characteristics in a second recording layer of the optical recording medium, resulting in completion of the invention according to this application. That is, this application is characterized in that the intermediate layer provided between two recording layers is composed of a resin having a glass transition temperature of 90° C. or greater in the optical recording medium.

First, the optical recording medium 1 of the first embodiment has a first substrate 11A, a first recording layer 21A composed of an organic pigment as a recording medium, an optically semi-transparent first reflection layer 31A, an optically transparent intermediate layer 4, a second recording layer 22A composed of an organic pigment as a recording medium, a second reflection layer 32A and a second substrate 12A deposited in order as shown in FIG. 2. The first substrate 11A has pregrooves of first grooves G1A on the first recording layer 21A side, and the first recording layer 21A has a shape following the grooves formed in the first substrate 11A. The intermediate layer 4 has pregrooves of second grooves G2A on the second recording layer 22A side, and the second recording layer 22A has a shape following the grooves formed in the intermediate layer 4. The second reflection layer 32A and the second substrate 12A are bonded together via an adhesive layer 5A.

As shown in FIG. 2, the optical recording medium 1 of the first embodiment is irradiated with recording laser light, reproducing laser light or recording and reproducing light laser light to perform recording and play back.

As a material of the first substrate 11A, a highly transparent resin, for example a resin having an optical transmittance of 80% or greater, more preferably 90% or greater for recording, reproducing or recording and reproducing laser light is used. And the examples of the resin include, but are not limited to, polycarbonate resins, acryl based resins such as polymethyl methacrylate and polyolefin based resins.

A thickness of the first substrate 11A conforms to specifications of the optical recording medium 1, but is usually 0.1 to 0.6 mm. That is, the thickness of the first substrate 11A is 0.6 mm if the optical recording medium 1 is a DVD-R disc for red laser. And the thickness of the first substrate 11A (corresponding to a transparent layer for recording and reproducing laser light) is 0.1 mm or 0.6 mm if the optical recording medium 1 is a disc for blue laser. For the first substrate 11A, a circular plate substrate having a hollow in the center is used.

The pregrooves of the first grooves G1A are formed on the first substrate 11A on a side on which the first recording layer 21A is formed. The pregrooves usually have as a shape a depth of about 140 to 180 nm, a width of about 0.25 to 0.35 μm and a pitch of about 0.7 to 0.9 μm.

The pregrooves of the first grooves G1A are formed in a helical form or centric form with respect to a center of the circular first substrate 11A. The first grooves G1A may meander in a radius direction in a predetermined cycle. Hereinafter, such meandering grooves are referred to as wobble grooves. Prepits dealing with address information and the like can be formed at predetermined intervals in lands situated between first grooves G1A.

For a material of the first recording layer 21A composed of an organic pigment (organic dye), an organic pigment for use in the recording layer of the conventional optical recording medium should be used and for example, an azo compound complex, cyanine pigment, phthalocyanine pigment or the like is used, but the material is not specifically limited. A thickness of the first recording layer 21A is not specifically limited, but is usually about 50 to 120 nm.

The first recording layer 21A may be formed in almost a uniform thickness along first grooves G1A and lands between the grooves. As shown in FIG. 2, the first recording layer 21A may be formed to have the first grooves G1A buried therein, and formed into a flat face on a side on which the first reflection layer 31A is provided.

As a material of the first reflection layer 31A, metals such as gold, aluminum, silver and copper, and alloys composed of such metals are used, but the material is not specifically limited. A thickness of the first reflection layer 31A is not specifically limited as long as it allows recording/reproducing laser light to be reflected or transmitted, but the thickness is usually about 10 nm±2 nm. If the first recording layer 21A is formed as a flat face on the first reflection layer 31A side, as described above, the first reflection layer 31A may be formed such that a face on the first substrate 11A side is parallel to a light admittance face of the first substrate 11A, and flat.

For a material of the intermediate layer 4, a resin having optical transparency and having a glass transition temperature of 90° C. (90 degrees C.) or greater is used. An upper limit of a glass transition temperature of the resin as the material of the intermediate layer 4 is not specifically limited, but is usually about 160° C. The resin as the material of the intermediate layer 4 preferably has a glass transition temperature of 110° C. or greater. And the resin as the material of the intermediate layer 4 more preferably has a glass transition temperature of about 110 to 150° C.

For the material of the intermediate layer 4, a material, which is capable of forming the second grooves G2A having a same phase structure as the first grooves G1A formed on the first substrate 11A, is preferably used. As the material of the intermediate layer 4, an ultraviolet curable resin is preferably used.

Specifically, resins that are used for the intermediate layer 4 include resins containing 90% or over by mass of acrylic ester.

A thickness of the intermediate layer 4 is not specifically limited, but is normally about 40 μm.

The pregrooves of the second grooves G2A are formed on the intermediate layer 4 on a side on which the second recording layer 22A is formed. These pregrooves have a shape of a depth, a width and a pitch that is in same ranges as those of the first grooves G1A described above. In this way, by making the first grooves G1A and the second grooves G2A have same structures when seen from a recording/reproducing laser light admission side, reproducing signal characteristics in the second recording layer 22A and the first recording layer 21A can be equalized.

A material and a thickness of the second recording layer 22A composed of an organic pigment are in same ranges of the material and the thickness of the first recording layer 21A. Owing to such configurations of the first recording layer 21A and the second recording layer 22A, reproducing signal characteristics of information recorded in the first recording layer 21A and the second recording layer 22A can be equalized.

The second recording layer 22A may be formed in almost a same thickness along second grooves G2A and lands between the grooves as in the case of the first recording layer 21A described above. As shown in FIG. 2, the second recording layer 22A may be formed to have the second grooves G2A buried therein, and formed into a flat face on a side on which the second reflection layer 32A is provided.

A material of the second reflection layer 32A is same as the material of the first reflection layer 31A described above. However, the material of the second reflection layer 32A is not required to have both optical reflectivity and optical transparency like the first reflection layer 31A, and should only be capable of fully reflecting recording/reproducing laser light.

A thickness of the second reflection layer 32A is appropriately selected in a range allowing recording/reproducing laser light to be fully reflected. A thickness of the second reflection layer 32A is, for example, 50 nm or greater. If the recording layer 22A is formed as a flat face on the second reflection layer 32A side as described above, the second reflection layer 32A may be formed such that a face on the first substrate 11A side is parallel to the light admittance face of the first substrate 11A, and flat. Consequently, as described later, flat faces of the second reflection layer 32A and the second substrate 12A are bonded together, and therefore these layers can easily be bonded.

The second substrate 12A has a material, a thickness and a shape that are same as those of the first substrate 11A.

The second reflection layer 32A and the second substrate 12A are bonded together via the adhesive layer 5A. As a material of an adhesive for the adhesive layer 5A, an ultraviolet curable resin and the like are used, but not limited thereto. A thickness of the adhesive layer 5A composed of an adhesive is not specifically limited, but is usually about 20 μm.

The optical recording medium 1 is not specifically limited to a layer configuration shown in FIG. 2, and other layers may be provided thereon as appropriate as long as it has the layers described above.

For example, a dielectric layer (not shown) may be provided in the optical recording medium 1. This dielectric layer is formed between the intermediate layer 4 and the second recording layer 22A in the optical recording medium 1. Specifically, the dielectric layer is formed along the second grooves G2A formed in the intermediate layer 4. This dielectric layer is provided for protecting the second recording layer 22A and adjusting optical characteristics and thermal characteristics of the optical recording medium 1.

A material of the dielectric layer is not specifically limited, and a well known material is used, but ZnS—SiO₂, SiO₂, AlN or the like is usually used. A thickness of the dielectric layer is not specifically limited, and is usually about 1 to 10 nm.

In the optical recording medium 1 in FIG. 2, the first grooves G1A and the second grooves G2A are provided at positions in which they are synchronized (i.e. mutually overlap) in a direction orthogonal to a tracking direction. However, an arrangement of the first grooves G1A and the second grooves G2A is not limited thereto, and the positions of the grooves may be positions with a phase difference (i.e. mutually shifted).

The optical recording medium 1 is irradiated with recording laser light or recording and reproducing laser light from the first substrate 11A side to form pits in the first recording layer 21A within the first grooves G1A or on the lands, and in the second recording layer 22A within the second grooves G2A or on the lands. The optical recording medium 1 is irradiated with reproducing laser light or recording and reproducing laser light from the first substrate 11A side to read pit information formed in the first recording layer 21A and the second recording layer 22A.

For the optical recording medium 1, for example, discs capable of recording/reproducing such as so called DVD-R discs and DVD-RW discs are used. There is no specific limitation on whether deletion and rewrite of recorded matters are possible or not. The recording medium is not limited to the organic pigments described above, but various kinds of recording media matching the format can be used as long as the conditions related to this technique described above are matched.

The method for production of the optical recording medium 1 of the first embodiment will now be described.

The method for production of the optical recording medium 1 of the first embodiment is not limited as long as the configuration described above is provided, but it can be produced by a method described below.

The optical recording medium 1 of the first embodiment is produced by forming the first grooves G1A on the first substrate 11A, depositing the first recording layer 21A composed of an organic pigment and the first reflection layer 31A in order on the first substrate 11A on the first groove G1A side, depositing the intermediate layer 4 composed of a resin having a glass transition temperature of 90° C. or greater, forming the second grooves G2A on the intermediate layer 4 on a side on which the first reflection layer 31A is not provided, depositing the second recording layer 22A composed of an organic pigment and the second reflection layer 32A in order on the intermediate layer 4 on the second groove G2A side, and bonding together the second reflection layer 32A and the second substrate 12A.

Specifically, the first grooves G1A having the above shape are first formed on one face of the first substrate 11A having the material and thickness described above. A method for formation of the first grooves G1A is not specifically limited, but a well known method using a photoresist, stamper or the like is used.

Then, the first recording layer 21A having the material and thickness described above is formed on the first grooves G1A formed on the first substrate 11A. A method for formation of the first recording layer 21A is not specifically limited, but a spin coating method or the like is usually used. Specifically, if the first recording layer 21A is formed by the spin coating method, the material of the first recording layer 21A is dissolved and dispersed in a solvent as a coating solution, and this coating solution is spin-coated onto the first substrate 11A.

If the azo compound complex described above is used as the material of the first recording layer 21A, tetrafluoropropanol, octafluoropentanol or the like is used as the solvent of the coating solution. If the cyanine pigment described above is used as the material of the first recording layer 21A, ethylcellosolve, dimethylcyclohexane or the like is used as the solvent of the coating solution.

Then, the first reflection layer 31A having the material and thickness described above is formed on the first recording layer 21A. A method for formation of the first reflection layer 31A is not specifically limited, but a sputtering method, vapor deposition method or the like is usually used.

Then, the intermediate layer 4 having the material and thickness described above is formed on the first reflection layer 31A. A method for formation of the intermediate layer 4 is not specifically limited, but the spin coating method or the like is usually used if the ultraviolet curable resin is used as the material of the intermediate layer 4.

Then, the second grooves G2A having the shape described above are formed on a face of the intermediate layer 4 in which the first reflection layer 31A is not provided. A method for formation of the second grooves G2A is not specifically limited.

But if the ultraviolet curable resin described above is used as the material of the intermediate layer 4, the second grooves G2A can be formed by pressing a stamper matching a shape of the second grooves G2A against the intermediate layer 4 and applying ultraviolet light thereto.

Then, the second recording layer 22A having the material and thickness described above is formed on the second grooves G2A formed in the intermediate layer 4. A method for formation of the second recording layer 22A is same as the method for formation of the first recording layer 21A. The second recording layer 22A is preferably formed such that a face on the second reflection layer 32A side is parallel to the light admittance face of the first substrate 11A, and flat.

Then, the second reflection layer 32A having the material and thickness described above is formed on the second recording layer 22A. A method for formation of the second reflection layer 32A is same as the method for formation of the first reflection layer 31A.

Then, the second substrate 12A is bonded to the second reflection layer 32A on a side on which the second recording layer 22A is not provided. For the bonding of the second reflection layer 32A and the second substrate 12A, the adhesive described above is used. The adhesive layer 5A composed of the adhesive is formed between the second reflection layer 32A and the second substrate 12A.

Specifically, the adhesive is coated to a bonding face of one of the second substrate 12A and the second reflection layer 32A by the spin coating method or the like, and a face to which the adhesive is not coated is superimposed on the coated adhesive and bonded under compression. If the ultraviolet curable adhesive described above is used as the adhesive, ultraviolet light is applied after the bonding under compression, whereby the adhesive is cured to bond together the substrates 11A and 12A.

If the dielectric layer (not shown) described above is formed, the dielectric layer is formed on the second grooves G2A in the intermediate layer 4. A method for formation of the dielectric layer is not specifically limited, and a well known method is used. But as a method for formation of the dielectric layer, the sputtering method, vapor deposition method or the like is usually used.

In this way, the optical recording medium 1 according to the first embodiment is produced.

As described above, the optical recording medium 1 of the first embodiment is an optical recording medium having a structure comprising at least a first substrate 11A, a first recording layer 21A capable of optical recording, a first reflection layer 31A, an intermediate layer 4, a second recording layer 22A capable of optical recording, a second reflection layer 32A and a second substrate 12A in this order from a side on which recording, reproducing or recording and reproducing laser light is applied, wherein the intermediate layer 4 is composed of a resin having a glass transition temperature of not less than 90° C.

In the optical recording medium 1 of the first embodiment, a resin having a glass transition temperature of 90° C. or greater as the material of the intermediate layer 4 provided between the first recording layer 21A and the second recording layer 22A, whereby recording/reproducing characteristics of the optical recording medium 1 are improved. Specifically, the optical recording medium 1 of the first embodiment allows a specific modulation degree and reflection coefficient to be obtained in the first recording layer 21A and the second recording layer 22A. The optical recording medium 1 of the first embodiment has characteristics, which have been possessed by so called dual layer type optical recording media, such that high density and large volume information recording is possible, a configuration of recording/reproducing apparatus is simplified, seamless recording/reproducing can be performed, and so on.

In the optical recording medium 1, the first substrate 11A has first pregrooves of first grooves G1A on the first recording layer 12A side, and the intermediate layer 4 has second pregrooves of second grooves G2A on the second recording layer 22A side.

The pregrooves of the first groove G1A are formed in the first substrate 11A, and the pregrooves of the second groove G2A are formed in the intermediate layer 4. Consequently, the first recording layer 21A and the second recording layer 22A formed on the pregrooves can have same phase structures when seen from the first substrate side, and reproducing signal characteristics obtained from both recording layers 21A and 22A are equalized.

In the optical recording medium 1, intermediate layer 4 is composed of an ultraviolet curing resin.

Since the intermediate layer 4 is formed using an ultraviolet curable resin, the second grooves G2A having a same phase structure as the first grooves G1A formed in the first substrate 1A can be reliably formed in the intermediate layer 4. Accordingly, the first recording layer 21A and the second recording layer 22A can be reliably made to have same phase structures when seen from the first substrate side, resulting in an improvement in reproducing signal characteristics obtained from both recording layers 21A and 22A.

Furthermore, The optical recording medium and the method for production of the same in the first embodiment may include configurations of second to fourth embodiments described later.

### EXAMPLES

Optical recording media of the first embodiment of this application will be described with reference to Examples A and Comparative Examples A.

### Example A1

Wobble grooves having a depth of 155 nm, a width of 310 nm and a track pitch of 0.74 μm were formed in a helical form as first grooves G1A in a disc-shaped first substrate 11A made of polycarbonate having a thickness of 0.6 mm, and prepits were formed at predetermined intervals in lands between the wobble grooves. On the first grooves G1A, a coating solution prepared by dissolving and dispersing an organic pigment composed of an azo compound complex in tetrafluoropropanol was coated by a spin coating method to form a first recording layer 21A having a thickness of 60 nm. Then, on the first recording layer 21A, an Ag—Pd—Cu alloy was deposited by sputtering to obtain a first reflection layer 31A having a thickness of 10 nm.

Then, on the first reflection layer 31A, an ultraviolet curable resin having a glass transition temperature of about 126° C. is spin-coated to form an intermediate layer 4 having a thickness of 50 μm. The ultraviolet curable resin contains 90% by mass of acrylate as a main component.

Then, second grooves G2A having a depth, a width and a track pitch that were same as those of the first grooves G1A were formed on the intermediate layer 4. The second grooves G2A were formed by pressing against the intermediate layer 4 an optically transparent resin stamper having a predetermined pattern of wobbles and prepits, and irradiating the intermediate layer 4 with ultraviolet light via the stamper.

Then, on the second grooves G2A, a coating solution prepared by dissolving and dispersing an organic pigment composed of an azo compound complex in tetrafluoropropanol was coated by a spin coating method to form a second recording layer 22A having a thickness of 60 nm as in the case of the first recording layer 21A. Then, on the second recording layer 22A, silver (Ag) was deposited by sputtering to obtain a second reflection layer 32A having a thickness of 100 nm.

Then, the second reflection layer 32A and a disc-shaped second substrate 12A made of polycarbonate having a thickness of 0.6 mm were bonded together using an ultraviolet curable adhesive, and the adhesive was cured by irradiation with ultraviolet light to form an adhesive layer 5A. In this way, an optical recording layer 1 of Example A1 was fabricated.

### Examples A2 to A6

An optical recording medium of Example A2 was fabricated in a same manner as in Example A1 except that the ultraviolet curable resin having a glass transition temperature of about 126° C., used as the intermediate layer of Example A1, was replaced with an ultraviolet curable resin having a glass transition temperature of about 133° C. Similarly, optical recording media of Examples A3 to A6 were fabricated using resins different only in glass transition temperature from the ultraviolet curable resin having a glass transition temperature of about 126° C., used as the intermediate layer.

### Comparative Examples A1 to A3

An optical recording medium of Comparative Example A1 was fabricated in a same manner as in Example A1 except that the ultraviolet curable resin having a glass transition temperature of about 126° C., used as the intermediate layer of Example A1, was replaced with an ultraviolet curable resin having a glass transition temperature of about 80° C. Similarly, optical recording media of Comparative Examples A2 and A3 were fabricated using resins different only in glass transition temperature from the ultraviolet curable resin having a glass transition temperature of about 126° C., used as the intermediate layer.

(Evaluation Method)

For optical recording media of Examples A1 to A6 and Comparative Examples A1 to A3, recording/reproducing characteristics of the second recording layer in each optical recording medium were measured using a disc evaluation apparatus (DDU-1000 manufactured by Pulstec Kogyo Kabshikigaisya). Results of measurement are shown in Table 1.

TABLE 1

| | Glass | | |
|---|---|---|---|
| | transition | Modulation | Reflection |
| | temperature | degree | coefficient |
| | Tg[° C.] | [%] | [%] |
| Examples A1 | 126 | 64.0 | 18.0 |
| Examples A2 | 133 | 64.0 | 18.3 |
| Examples A3 | 140 | 62.0 | 19.0 |
| Examples A4 | 155 | 60.0 | 19.8 |
| Examples A5 | 117 | 64.0 | 18.8 |
| Examples A6 | 92 | 60.0 | 19.4 |
| Comparative | 80 | Measurement | Measurement |
| Examples A1 | | impossible | impossible |
| Comparative | 82 | Measurement | Measurement |
| Examples A2 | | impossible | impossible |
| Comparative | 82 | Measurement | Measurement |
| Examples A3 | | impossible | impossible |

As shown in Table 1, a specific modulation degree and reflection coefficient could be obtained in the second recording layer from the optical recording medium according to each Example A of this application. In this way, characteristics required for recording and reproducing of information could be obtained from the optical recording medium according to each Example A of this application.

From the optical recording medium according to each Comparative Example A, an appropriate reproducing signal could not be obtained from the second recording layer, so that the modulation degree and the reflection coefficient could not be measured. Specifically, in the optical recording medium of Comparative Example A1, an optical disc evaluation apparatus possessed by an applicant was used to try to play back recorded information, but tracking was not locked to optimum characteristics, and thus no reproducing signal could be obtained. In the optical recording media of Comparative Examples A2 and A3, a tracking error signal (TE) was low and tracking loop was not closed, so that no reproducing signal could be obtained as in the case of Comparative Example A1. In this way, in the optical recording medium according to each Comparative Example A, tracking was not operated normally, and recording/reproducing characteristics were poor.

(Second Embodiment)

An optical recording medium of the second embodiment according to this technique and a method for production of the same will be described specifically below.

As specifications of two layer discs in which both recording layers are ROMs, a coefficient of reflection from a recording layer is specified as 18% or greater.

As a result of vigorous studies in improving a reflection coefficient in each recording layer to be a predetermined value or greater for maintaining compatibility with the ROM type optical recording medium in a writing optical recording medium, it was found that if a certain requirement is met between a real part n and an imaginary part k in a relational expression of a complex refractive index in each recording layer, a reflection coefficient from each recording layer has a predetermined value, e.g. 18% or greater, and this technique is based on the findings.

As well known, the complex refractive index N is expressed by a mathematical expression of N=n+ik using a refractive index n as the real part and an attenuation coefficient k as the imaginary part in a theoretical relational expression of electromagnetic waves.

This technique is an optical recording medium having a structure comprising at least a first substrate, a first recording layer capable of optical recording, a first reflection layer, an intermediate layer, a second recording layer capable of optical recording, a second reflection layer and a second substrate in this order from a side on which recording, reproducing or recording and reproducing laser light is applied, characterized in that the real part n and the imaginary part k of the complex refractive coefficient N=n+ik of the first recording layer and second recording layer meet a requirement of k≦0.125n−0.175, 2≦n≦3.

In the requirement described above, n is preferably in a range of 2.0 to 2.7.

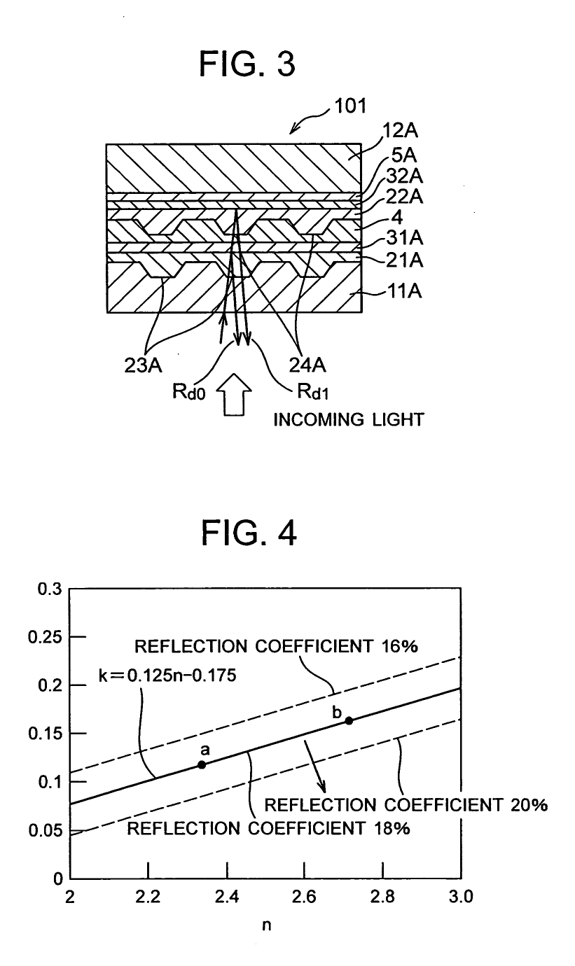

For example, in the optical recording medium having a layer structure described later, (a) if the first recording layer and the second recording layer were formed with an organic pigment, and an Ag—Pd—Cu based metal was used as an optically semi-transparent reflection layer, and if a pigment thickness thereof was set to 60 nm, a reflection coefficient R_{d0} from the first recording layer and a reflection coefficient R_{d1} from the second recording layer (see FIG. 3 for R_{d0} and R_{d1}) were both 18% at a reflection thickness of 10 nm when a pigment with n=2.352 and k=0.119 was used (hereinafter referred to as “Example B1”).

(b) If the first recording layer and the second recording layer were formed with an organic pigment, and an Ag—Pd—Cu based metal was used as an optically semi-transparent reflection layer, and if a pigment thickness thereof was set to 56 nm, the reflection coefficient R_{d0} from the first recording layer and the reflection coefficient R_{d1} from the second recording layer were both 18% when a pigment with n=2.68 and k=0.16 was used (hereinafter referred to as “Example B2”).

FIG. 4 is a graph showing, together with the above data, an area in which the conditions of this technique are met. In this figure, [point a] corresponds to a value in the requirement of (a), and [point b] corresponds to a value in the requirement of (b). Lines of reflection coefficients of 16% and 20% shown with broken lines represent estimated values.

Here, in a dual layer type writing optical recording medium, the reflection coefficient R_{d0} from the first recording layer located on a side on which recording, reproducing or recording and reproducing laser light is applied approximates to a reflection coefficient R_{L0} of a single layer of the first recording layer. The reflection coefficient R_{d1} from the second recording layer located at a distance from the first substrate approximates to a value obtained by multiplying a reflection coefficient R_{L1} of a single layer of the second recording layer by a square of an optical transmittance T_{L0} of the first substrate (R_{d1}=T_{L0}²×R_{L1}) because light entering the second recording layer and light reflected from the second recording layer are at least influenced by the optical transmittance T_{L0} of the first substrate on an optical path thereof (of course, more accurately, it is also influenced by the optical transmittance of the intermediate layer and the like existing on the optical path). Accordingly, for obtaining a predetermined reflection coefficient, i.e. 18% or greater from both recording layers, it is ensured that a predetermined reflection coefficient, i.e. 18% or greater can be obtained from the first and second recording layers when the above requirements in this technique are met by observing correlations of these parameters.

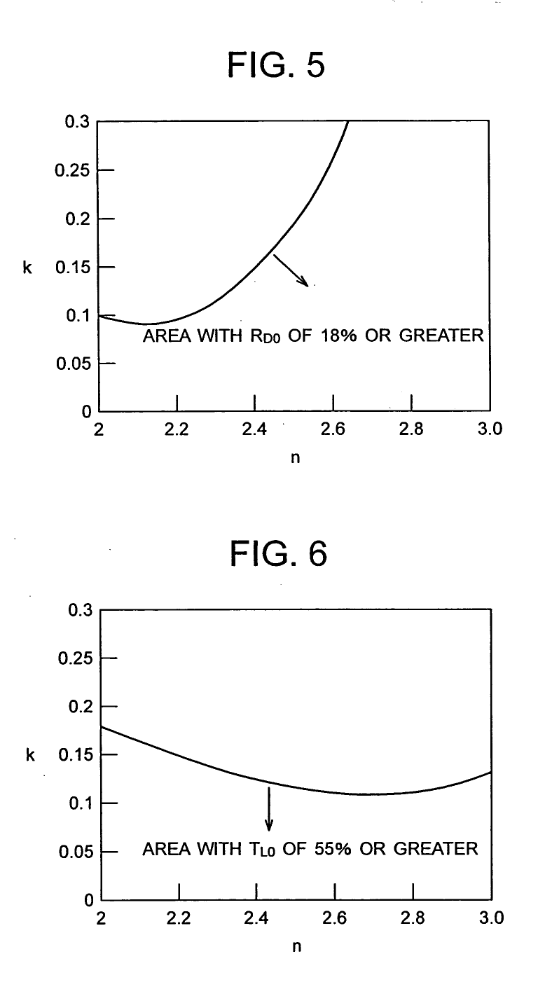

FIG. 5 shows an area in which the reflection coefficient R_{d0} from the first recording layer is 18% or greater in a same structure (pigment thickness of recording layers 21A and 22A, thickness of optically semi-transparent reflection layer 31A) as Example B1. FIG. 6 shows an area in which the same optical transmittance T_{L0} as Example B1 can be obtained at this time. FIG. 7 shows an area in which the reflection coefficient R_{L1} of the single layer of the second recording layer is same as that in Example B1 when a thickness is same as that in Example B1.

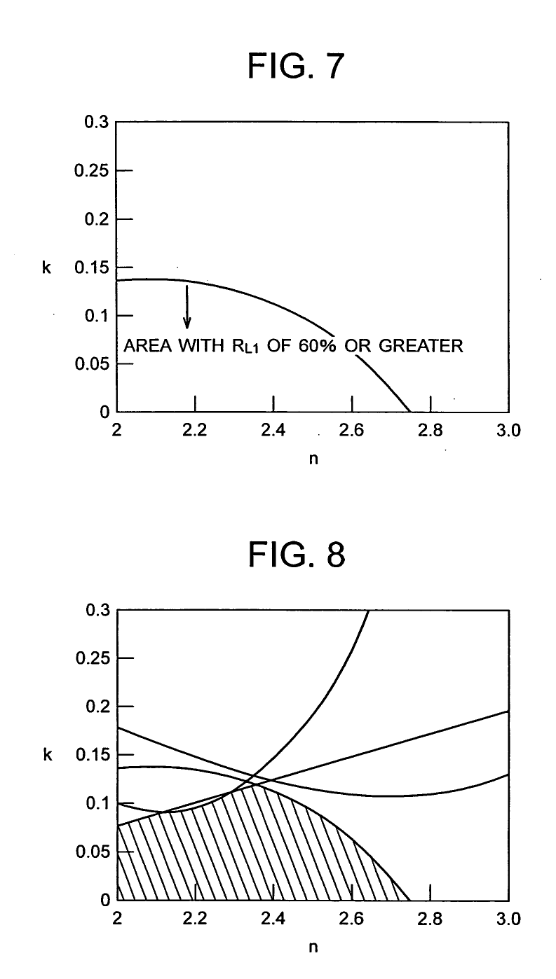

In Example B1, the reflection coefficients R_{d0} and R_{d1} from both recording layers are both 18% as described previously. Therefore as shown in FIG. 8, a part where three areas shown in FIGS. 5, 6 and 7 overlap is an area in which the reflection coefficient R_{d0} from the first recording layer and the reflection coefficient R_{d1} from the second recording layer are both 18% or greater in a same structure (pigment thickness, thickness of optically semi-transparent film) as that in Example B1, and high consistency with a requirement range of k≦0.125n−0.175 described above in this technique is shown. A predetermined reflection coefficient cannot be obtained in a range where n is a high number even if the requirement range of k≦0.125n−0.175 described above in this technique is met depending on the same structure (pigment thickness, thickness of optically semi-transparent film) as-that in Example B1. But a predetermined reflection coefficient can be obtained by changing the structure (pigment thickness of recording layers, thickness of optically semi-transparent reflection layer) of the recording medium. This will be apparent from the fact that in Example B2, a predetermined reflection coefficient is obtained by changing the thickness of the optically semi-transparent film 31A.

In this technique, the real part n and the imaginary part k of the complex refractive coefficient N=n+ik of the first recording layer and the second recording layer can be made to meet the requirement of k≦0.125n−0.175, 2≦n≦3 by appropriately adjusting types of organic pigment and the like that are used as recording media material constituting first and second recording layers 21A and 22A, thicknesses of the first and second recording layers 21A and 22A, a thickness of the optically semi-transparent reflection layer 31A, or the like.

A specific configuration of the optical recording medium 101 of the second embodiment is shown in FIG. 3.

FIG. 3 is a sectional view showing part of a cross section in a direction vertical to a disc face of the optical recording medium of the second embodiment. In FIG. 3, the thickness of each layer is exaggerated.

The specific configuration of the optical recording medium 101 of the second embodiment is same as that of the optical recording medium 1 of the first embodiment except that the complex refractive index of the first recording layer and the second recording layer is in the range described above. A configuration of the intermediate layer 4 in the optical recording medium 101 of the second embodiment is limited to the configuration in the first embodiment.

As described above, the optical recording medium 1 of the second embodiment is an optical recording medium having a structure comprising at least the first substrate 11A, the first recording layer 21A capable of optical recording, the first reflection layer 31A, the intermediate layer 4, the second recording layer 22A capable of optical recording, the second reflection layer 32A and the second substrate 12A in this order from a side on which recording, reproducing or recording and reproducing laser light is applied, wherein the real part n and the imaginary part k of the complex refractive coefficient N=n+ik of the first recording layer and second recording layer meet a requirement of k≦0.125n−0.175, 2≦n≦3.

For the optical recording medium 1 of the second embodiment, a high reflection coefficient, i.e. 18% or greater can be obtained in each of the first recording layer 21A and the second recording layer 22A if reproducing or recording and reproducing laser light is applied to the recording layers 21A and 22A in grooves 23A and 24A from the first substrate 11A side to reproduce information, and thus a ROM compatible writing recording medium excellent in general versatility can be provided. The optical recording medium 101 of the second embodiment has characteristics, which have been possessed by so called dual layer type optical recording media, such that high density and large volume information recording is possible, a configuration of recording/reproducing apparatus is simplified, seamless recording/reproducing can be performed, and so on.

The method for production of the optical recording medium 101 of the second embodiment will now be described.

The optical recording medium 101 of the second embodiment is produced by forming grooves at a predetermined position on one face of the first substrate 11A, depositing an organic pigment as a recording medium to form the first recording layer 21A having first grooves 23A having a shape following the grooves of the first substrate 11A on the face of the first substrate 1A on which the grooves are formed, then depositing the first reflection layer 31A on the first recording layer 21A, depositing the intermediate layer 4 on the first reflection layer 31A, forming grooves recessed toward the first substrate side on an opposite face of the intermediate layer 4, then depositing an organic pigment as a recording medium to form the second recording layer 22A having second grooves 24A having a shape following the grooves of the intermediate layer 4, depositing the second reflection layer 32A on the second recording layer 22A, and depositing the second substrate 12A on the second reflection layer 32A via, for example, an adhesive layer 5A. Types of organic pigments and the like that are used as recording media constituting the first and second recording layers, thicknesses thereof, a thickness of an optically semi-transparent layer or the like are adjusted as appropriate so that the real part n and the imaginary part k of the complex refractive index N=n+ik of the first recording layer and second recording layer meet the requirement of k≦0.125n−0.175, 2≦n≦3.

Specific steps in the method for production of the optical recording medium 101 of the second embodiment are same as the specific steps in the method for production of the optical recording medium 1 of the first embodiment except that the complex refractive index of the first recording layer and the second recording layer is in the range described above.

According to the production method of the second embodiment described above, a structure having a high reflection coefficient, which is compatible with a ROM type optical recording medium, can easily be formed as a dual layer type optical recording medium. Since it is not necessary to form an adhesive layer at a location having influences on the organic pigment of the recording layer, there is no possibility that characteristics of the optical recording medium are degraded by the adhesive. The method for production of the optical recording medium of the second embodiment is not limited to the method in the embodiment described above. The optical recording medium can be produced by, for example, a bonding method as previously known.

Furthermore the optical recording medium of the second embodiment and the method for production of the same may include a configuration of the third embodiment or fourth embodiment described later.

(Third Embodiment)

An optical recording medium of the third embodiment according to this application and a method for production of the same will be described below with reference to FIG. 2.

First, a configuration of the optical recording medium of the third embodiment will be described.

As shown in FIG. 2, the optical recording medium 1 of the third embodiment has a first substrate 11A, a first recording layer 21A capable of optical recording, a first reflection layer 31A, an intermediate layer 4, a second recording layer 22A capable of optical recording, a second reflection layer 32A and a second substrate 12A deposited in this order from a side on which recording, reproducing or recording and reproducing laser light is applied. The first substrate 11A has first grooves G1A on the first recording layer 21A side, and the intermediate layer 4 has second grooves G2A on the second recording layer 22A side.

The specific configuration of the optical recording medium 1 of the third embodiment is same as the specific configuration of the optical recording medium 1 of the first embodiment except that the first substrate 11A has on the first recording layer 21A side the first grooves G1A recessed toward the first substrate 11A side, and the intermediate layer 4 has on the second recording layer 22A side the second grooves G2A recessed toward the first substrate 11A side. Furthermore a configuration of the intermediate layer 4 in the optical recording medium 1 of the third embodiment is not limited to the configuration in the first embodiment.

This optical recording medium 1 of the third embodiment has the first recording layer 21A on the first grooves G1A of the first substrate 11A and has the second recording layer 22A on the second grooves G2A of the intermediate layer 4. Thus making it possible to form the recording layers 21A and 22A on the grooves G1A and G2A having similar shapes. Accordingly, the first recording layer 21A and the second recording layer 22A can be made to have same phase structures when seen from the first substrate 1A side with same materials and in a same thickness. And therefore even if refractive indexes in recorded pit portions in the recording layers 21A and 22A decrease, the recording layers 21A and 22A have optical depths of pit portions changed equally. Thus, in optical recording medium 1 of the third embodiment, characteristics of signals reproduced from the recording layers 21A and 22A are equalized, and thus other problems are hard to occur.

In the optical recording medium 1 of the third embodiment, the first reflection layer 31A is formed on the first recording layer 21A, and therefore a range of selection of a material that is used for the intermediate layer 4 formed thereon is extended. In the optical recording medium 1 of the third embodiment, the second reflection layer 32A is formed on the second recording layer 22A, and therefore a range of selection of a material that is used for an adhesive layer 5A formed thereon is extended. The optical recording medium 1 of the third embodiment has characteristics, which have been possessed by so called dual layer type optical recording media, such that high density and large volume information recording is possible, a configuration of recording/reproducing apparatus is simplified, seamless recording/reproducing can be performed, and so on.

In the optical recording medium 1 of the third embodiment, the first reflection layer 31A and the second reflection layer 32A each have a flat face on the first substrate 11A side.

Recording beam light and reproducing beam light can be reflected uniformly and equally at any position in the reflection layers 31A and 32A. Accordingly a function for equalization of characteristics of signals reproduced from the recording layers 21A and 22A is further improved.

In the optical recording medium 1 of the third embodiment, the intermediate layer 4 has a dielectric layer on the second grooves G2A on the second recording layer 22A side.

The second recording layer 22A in the optical recording medium 1 can be protected, and optical characteristics and thermal characteristics of the optical recording medium 1 can be adjusted.

In the optical recording medium 1 of the third embodiment, the intermediate layer 4 is composed of an ultraviolet curing resin.

The second grooves G2A same as the first grooves G1A formed on the substrate 1A can be reliably formed in the intermediate layer 4. Accordingly, the first recording layer 21A and the second recording layer 22A can be formed with same materials and in a same thickness, and reliably made to have same phase structures when seen from the first substrate side, and equality of characteristics of reproducing signals obtained from the recording layers 21A and 22A is improved.

In the optical recording medium 1 of the third embodiment, a shape of the first grooves G1A of the first substrate 11A and the first recording layer 21A, and a shape of the second grooves G2A of the intermediate layer 4 and the second recording layer 22A have same phase structures when seen from the first substrate side.

Equality of characteristics of reproducing signals obtained from the recording layers 21A and 22A is improved.

The method for production of the optical recording medium 1 of the third embodiment will now be described.

The method for production of an optical recording medium 1, the first grooves G1A are formed on a first substrate 11A, a first recording layer 21A capable of optical recording, a first reflection layer 31A and an intermediate layer 4 are deposited in order on the first substrate 11A on the first groove G1A side, second grooves G2A are formed on the intermediate layer 4 on a side on which the first reflection layer 31A is not provided, a second recording layer 22A capable of optical recording and a second reflection layer 32A are deposited in order on the intermediate layer 4 on the second groove G2A side, and the second reflection layer 32A and a second substrate 12A are bonded together.

Specific steps in the method for production of the optical recording medium 1 of the third embodiment are same as specific steps in the method for production of the optical recording medium 1 of the first embodiment except that the first substrate 1A has on the first recording layer 21A side the first grooves G1A recessed toward the first substrate 11A side, and the intermediate layer 4 has on the second recording layer 22A side the second grooves G2A recessed toward the first substrate 11A side.

As described above, the optical recording medium 1 of the third embodiment is, the first grooves G1A are formed on a first substrate 11A, a first recording layer 21A capable of optical recording, a first reflection layer 31A and an intermediate layer 4 are deposited in order on the first substrate 11A on the first groove G1A side, second grooves G2A are formed on the intermediate layer 4 on a side on which the first reflection layer 31A is not provided, a second recording layer 22A capable of optical recording and a second reflection layer 32A are deposited in order on the intermediate layer 4 on the second groove G2A side, and the second reflection layer 32A and a second substrate 12A are bonded together.

The optical recording medium 1 produced by the production method of the third embodiment has the first recording layer 21A on the first grooves G1A of the first substrate 11A and has the second recording layer 22A on the second grooves G2A of the intermediate layer 4, thus making it possible to form the recording layers 21A and 22A on the grooves G1A and G2A having similar shapes. Accordingly, the first recording layer 21A and the second recording layer 22A can be made to have same phase structures when seen from the first substrate 11A side with same materials and in a same thickness, and therefore even if refractive indexes in recorded pit portions in the recording layers 21A and 22A decrease, the recording layers 21A and 22A have optical depths of pit portions changed equally. Thus, in the produced optical recording medium 1, characteristics of signals reproduced from the recording layers 21A and 22A are equalized, and thus information can be stably reproduced from the recording layers 21A and 22A.

In the optical recording medium 1 of the third embodiment, the first reflection layer 31A is formed on the first recording layer 21A, and therefore a range of selection of a material that is used for the intermediate layer 4 formed thereon is extended. In the optical recording medium 1 of the third embodiment, the second reflection layer 32A is formed on the second recording layer 22A, and therefore a range of selection of a material that is used for the adhesive layer 5A formed thereon is extended. The optical recording medium 1 produced by the production method of the third embodiment has characteristics, which have been possessed by so called dual layer type optical recording media, such that high density and large volume information recording is possible, the configuration of recording/reproducing apparatus is simplified, seamless recording/reproducing can be performed, and so on.

The optical recording medium of the third embodiment and the method for production of the same may include a configuration of the fourth embodiment described later.

### EXAMPLES

The optical recording medium of the third embodiment will be described with reference to Example C and Comparative Example C.

### Example C

Wobble grooves having a depth of 155 nm, a width of 310 nm and a track pitch of 0.74 to 0.8 μm were formed in a helical form as first grooves G1A on a disc-shaped first substrate 11A made of polycarbonate having a thickness of 0.6 mm, and prepits were formed at predetermined intervals on lands between the wobble grooves. On the first grooves G1A, a coating solution prepared by dissolving and dispersing an organic pigment composed of an azo compound complex in tetrafluoropropanol was coated by a spin coating method to form a first recording layer 21A having a thickness of 60 nm. Then, on the first recording layer 21A, an Ag—Pd—Cu alloy was deposited by sputtering to obtain a first reflection layer 31A having a thickness of 10 nm.

Then, on the first reflection layer 31A, an ultraviolet curable resin having a glass transition temperature of about 157° C. is spin-coated to form an intermediate layer 4 having a thickness of 50 μm. Then, on the intermediate layer 4, second grooves G2A having similar shapes as the first grooves G1A were formed. The second grooves G2A were formed by pressing against the intermediate layer 4 an optically transparent resin stamper having a predetermined pattern of wobble grooves and prepits, and irradiating the intermediate layer 4 with ultraviolet light via the stamper.

Then, on the second grooves G2A, a coating solution prepared by dissolving and dispersing an organic pigment composed of an azo compound complex in tetrafluoropropanol was coated by a spin coating method to form a second recording layer 22A having a thickness of 60 nm as in the case of the first recording layer 21A. Then, on the second recording layer 22A, silver (Ag) was deposited by sputtering to obtain a second reflection layer 32A having a thickness of 100 nm.

Then, the second reflection layer 32A and a disc-shaped second substrate made of polycarbonate having a thickness of 0.6 mm were bonded together using an ultraviolet curable adhesive, and the adhesive was cured by irradiation with ultraviolet light to form an adhesive layer 5A. In this way, an optical recording layer 1 of Example C was fabricated (see FIG. 2).

### Comparative Example C

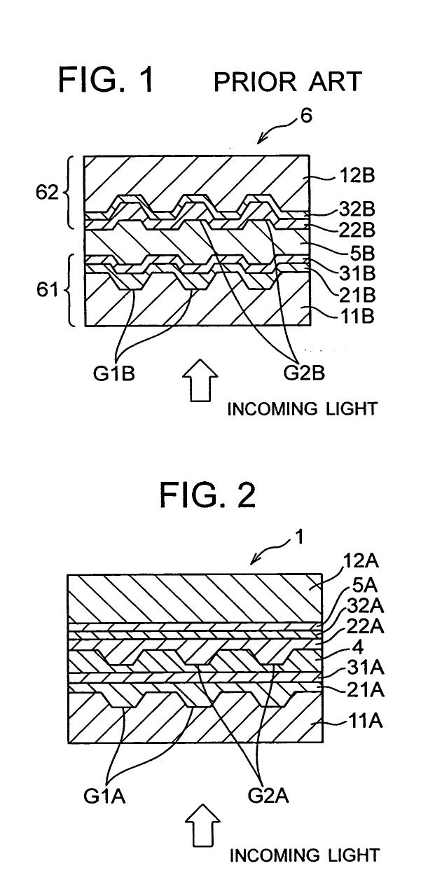

A first disc 61 comprised of a first substrate 11B, a first recording layer 21B and a first reflection layer 31B was fabricated using materials and a formation method same as those in Example C. Then, a second disc 62 having second grooves G2B same as the first grooves G1B formed on a second substrate 12B, and a second reflection layer 32B and a second recording layer 22B formed thereon was fabricated. The first disc 61 and the second disc 62 were bonded together with the substrates 11B and 12B situated outside using an adhesive, whereby an adhesive layer 5B was formed. In this way, an optical recording medium 6 of Comparative Example C was fabricated (see FIG. 1).

(Evaluation Method)

For optical recording media 1 of Example C and optical recording media 6 of Comparative Example C, characteristics of reproducing signals of the recording layers in the grooves G1A, G2A, G1B and G2B were measured using a disc evaluation apparatus (DDU-1000 manufactured by Pulstec Kogyo Kabushikigaisya). Reflection coefficients, modulation degrees and jitters were measured as characteristics of reproducing signals. Results of measurement are shown in Table 2.

TABLE 2

| | Example C | | Comparative Example C | |
|---|---|---|---|---|
| | First | Second | First | Second |
| | recording | recording | recording | recording |
| | layer | layer | layer | layer |
| Reflection | 18.4% | 18.4% | 15% | 16% |
| coefficient | | | | |
| Modulation | 73% | 66% | 84% | 70% |
| degree | | | | |
| Jitter | 9.2% | 8.1% | 9.5% | Measurement |
| | | | | impossible |

As shown in Table 2, there was no significant difference in reproducing signal characteristics of the reflection coefficient, modulation degree and jitter between the first recording layer 21A and the second recording layer 22A for the optical recording medium 1 according to Example C of this application. Thus, it can be said that in the optical recording medium 1 of Example C, the first recording layer 21A and the second recording layer 22A have almost equal reproducing signal characteristics.

For the optical recording medium 6 according to Comparative Example C, there was no significant difference in reflection coefficient between the first recording layer 21B and the second recording layer 22B. But there was a significant difference of reproducing signal characteristics of the modulation degree and jitter. Particularly, the jitter of the second recording layer 22B could not be measured. Thus, it can be said that in the optical recording medium 6 of Comparative Example C, the first recording layer 21B and the second recording layer 22B have unequal reproducing signal characteristics.

(Fourth Embodiment)

An optical recording medium of the fourth embodiment according to this application and a method for production of the same will be described specifically below with reference to drawings.

First, the optical recording medium of the fourth embodiment will be described.

As shown in FIG. 3, the optical recording medium 101 of the fourth embodiment has a first substrate 11A, a first recording layer 21A capable of optical recording, a first reflection layer 31A, an intermediate layer 4, a second recording layer 22A capable of optical recording, a second reflection layer 32A and a second substrate 12A deposited in this order from a side on which recording, reproducing or recording and reproducing laser light is applied. First grooves 23A having a shape following grooves formed on the first substrate 11A are formed on the first recording layer 21A, and second grooves 24A having a shape following grooves formed on the intermediate layer 4 are formed on the second recording layer 22A.

And, a depth G1 of the first grooves 23A and a depth G2 of the second grooves 24A should meet a requirement of G1<G2. The depth G2 is preferably about 1.2 to 1.5 times, more preferably about 1.3 to 1.4 times as large as the depth G1.

A specific configuration in the optical recording medium 101 of the fourth embodiment is same as the specific configuration of the optical recording medium 1 of the first embodiment except for the depth of grooves in the first substrate 11A and the intermediate layer 4.

That is, grooves same as grooves formed on the first substrate 11A are formed on the intermediate layer 4 on a side on which the second recording layer 22A is formed, but the grooves of the intermediate layer 4 are usually formed to have a depth larger than the depth of the grooves formed on the first substrate 11A so that the depth G1 of the first grooves 23A of the first recording layer 21A and the depth G2 of the second grooves 24A of the second recording layer 22A can meet the requirement of G1<G2 as described above. Other respects, i.e. a width, a pitch, a shape when seen from the grooves, etc. are usually same as those of the grooves formed on the first substrate 11A.

Furthermore a configuration of the intermediate layer 4 in the optical recording medium 101 of the fourth embodiment is not limited to the configuration in the first embodiment.

As described above, the optical recording medium 101 of the forth embodiment is, the optical recording medium 101 having a structure comprising at least a first substrate 11A, a first recording layer 21A capable of optical recording, a first reflection layer 31A, an intermediate layer 4, a second recording layer 22A capable of optical recording, a second reflection layer 32A and a second substrate 12A in this order from a side on which recording, reproducing or recording and reproducing laser light is applied, the first recording layer 21A has first grooves 23A recessed toward the first substrate 11A side, and second grooves 24A recessed toward the first substrate 11A side, and a depth G2 of the second grooves 24A is larger than a depth G1 of the first grooves 23A.

In the optical recording medium 101 of the fourth embodiment, an optical depth of a pit portion changes in the second recording layer 22A as in the first recording layer 21A if a refractive index of the recorded pit portion decreases when recording, reproducing or recording and reproducing laser light is applied to the recording layers 21A and 22A in the grooves 23A and 24A from the first substrate 11A side to perform recording and reproducing the optical recording medium 101. Thus, in the optical recording medium 101 of the fourth embodiment, characteristics reproduced from the recording layers 21A and 22A are equalized, and information can be stably reproduced from the recording layers 21A and 22A. Thus, the optical recording medium 101 of the fourth embodiment has characteristics, which have been possessed by so called dual layer type optical recording media, such that high density and large volume information recording is possible, a configuration of recording/reproducing apparatus is simplified, seamless recording/reproducing can be performed, and so on.

The method for production of the optical recording medium 101 of the fourth embodiment will now be described.

The optical recording medium 101 of the fourth embodiment is produced by forming grooves at a predetermined position on one face of the first substrate 11A, depositing an organic pigment as a recording medium to form the first recording layer 21A having first grooves 23A having a shape following the grooves of the first substrate on the face of the first substrate 11A on which the grooves are formed, then depositing the first reflection layer 31A on the first recording layer 21A, depositing the intermediate layer 4 on the first reflection layer 31A, forming grooves recessed toward the first substrate side on an opposite face of the intermediate layer 4, then depositing an organic pigment as a recording medium to form the second recording layer 22A having second grooves 24A having a shape following the grooves of the intermediate layer 4 and having a depth greater than that of the first grooves 23A on the face of the intermediate layer 4 on which the grooves are formed, depositing the second reflection layer 32A on the second recording layer 22A, and depositing the second substrate 12A on the second reflection layer 32A via, for example, an adhesive layer 5A.

Specific steps in the method for production of the optical recording medium 101 of the fourth embodiment are same as the specific steps in the method for production of the optical recording medium 1 of the first embodiment except for the depth of grooves in the first substrate 11A and the intermediate layer 4.

According to the production method according to the fourth embodiment described above, a structure comprising the second recording layer 22A having second grooves 24A having a depth larger than the depth of first grooves 23A of the first recording layer 21A can be easily be formed as a dual layer type optical recording medium. Since it is not necessary to form an adhesive layer at a location having influences on the organic pigment of the recording layer, there is no possibility that characteristics of the optical recording medium are degraded by the adhesive.

### EXAMPLES

The optical recording medium of the fourth embodiment will now be described specifically with reference to Example D and Comparative Example D.

### Example D

Wobble grooves having a depth of 155 nm, a width of 310 nm and a track pitch of 0.74 to 0.8 μm were formed in a helical form as grooves on a disc-shaped first substrate made of polycarbonate having a thickness of 0.6 mm, and prepits were formed at predetermined intervals on lands between the wobble grooves.

On a face of the first substrate on which grooves were formed, a coating solution prepared by dissolving and dispersing a metal-containing organic pigment composed of an azo compound complex in tetrafluoropropanol was coated by a spin coating method to form a first recording layer having a thickness of 60 nm. A depth G1 of first grooves formed on the first recording layer was 155 nm.

Then, on the first recording layer, an Ag—Pd—Cu alloy was deposited by sputtering to form a first reflection layer having a thickness of 11 nm.

An ultraviolet curable resin having a glass transition temperature of about 157° C. was spin-coated on the first reflection layer, an optically transparent resin stamper having a predetermined pattern of wobble grooves and prepits was pressed against the coated ultraviolet curable resin, and ultraviolet light was applied via the stamper to form an intermediate layer (thickness: 50 μm) having formed thereon a pattern of wobble grooves and prepits having a depth of 200 nm, a wide of 320 nm and a track pitch of 0.74 to 0.8 μm as grooves was formed.

Subsequently, on a face of the intermediate layer on which grooves were formed, a coating solution prepared by dissolving and dispersing an organic pigment composed of an azo compound complex in tetrafluoropropanol was coated by the spin coating method to form a second recording layer having a thickness of 60 nm as in the case of the first recording layer. A depth G2 of second grooves formed on the second recording layer was 200 nm.

Then, on the second recording layer, Ag was deposited by sputtering to form a second reflection layer having a thickness of 100 nm.

Finally, the second reflection layer and a disc-shaped second substrate made of 0.6 mm polycarbonate were bonded together using an ultraviolet curable adhesive, and ultraviolet light was applied to cure the adhesive, whereby an optical recording medium was fabricated.

For the obtained optical recording medium, modulation degree characteristics of reproducing signals were measured using a disc evaluating apparatus (DDU-1000 manufactured by Pulstec Kogyo Kabshikigaisya). As a result, the modulation degree of the first recording layer was 69%, while the modulation degree of the second recording layer was 60%, which indicates that almost equal reproducing signal characteristics could be obtained in both recording layers.

### Comparative Example D1

An optical recording medium was fabricated in a same manner as in Example D except that the depth G2 of the second grooves formed on the second recording layer was 160 nm, and modulation degree characteristics of reproducing signals were measured in the same manner.

As a result, the modulation degree of the first recording layer was 69%, while the modulation degree of the second recording layer was 37%, which indicates that reproducing signal characteristics were almost unequal in both recording layers.

### Comparative Example D2

An optical recording medium was fabricated in a same manner as in Example D except that the depth G2 of the second grooves formed on the second recording layer was 170 nm, and modulation degree characteristics of reproducing signals were measured in the same manner.

As a result, the modulation degree of the first recording layer was 69%, while the modulation degree of the second recording layer was 39%, which indicates that reproducing signal characteristics were almost unequal in both recording layers.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application Nos. 2003-344627 filed on Oct. 2, 2003, 2003-346043 filed on Oct. 3, 2003, 2003-341593 filed on Sep. 30, 2003 and 2003-341594 filed on Sep. 30, 2003 including the specification, claims, drawings and summary is incorporated herein by reference in its entirety.

1. An optical recording medium having a structure comprising at least a first substrate, a first recording layer capable of optical recording, a first reflection layer, an intermediate layer, a second recording layer capable of optical recording, a second reflection layer and a second substrate in this order from a side on which recording, reproducing or recording and reproducing laser light is applied,
wherein said intermediate layer is composed of a resin having a glass transition temperature of not less than 90° C.

2. The optical recording medium according to claim 1,
wherein said first substrate has first pregrooves of first grooves on said first recording layer side, and
said intermediate layer has second pregrooves of second grooves on said second recording layer side.

3. The optical recording medium according to claim 1,
wherein said intermediate layer is composed of an ultraviolet curing resin.

4. The optical recording medium according to claim 1,
wherein where a real part of complex refractive indexes of said first recording layer and said second recording layer is n, and an imaginary part of the complex refractive indexes is k, a requirement of k≦0.125n−0.175, 2≦n≦3 is met.

5. The optical recording medium according to claim 1,
wherein said first recording layer has first grooves recessed toward said first substrate side,
said intermediate layer has second grooves recessed toward said first substrate side, and
a depth of the second grooves is larger than a depth of the first grooves.

6. An optical recording medium having a structure comprising at least a first substrate, a first recording layer capable of optical recording, a first reflection layer, an intermediate layer, a second recording layer capable of optical recording, a second reflection layer and a second substrate in this order from a side on which recording, reproducing or recording and reproducing laser light is applied,
wherein where a real part of complex refractive indexes of said first recording layer and said second recording layer is n, and an imaginary part of the complex refractive indexes is k, a requirement of k≦0.125n−0.175, 2≦n≦3 is met.

7. The optical recording medium according to claim 6, wherein grooves are formed in a helical or centric form on said first substrate and said intermediate layer.

8. The optical recording medium according to claim 6,
wherein said first substrate has first grooves on said first recording layer side, and
said intermediate layer has second grooves on said second recording layer side.

9. The optical recording medium according to claim 6,
wherein said first recording layer has first grooves recessed toward said first substrate side,
said intermediate layer has second grooves recessed toward said first substrate side, and
a depth of the second grooves is larger than a depth of the first grooves.

10. A method for production of an optical recording medium comprising,
step of depositing a first recording layer capable of optical recording on a first substrate on one face,
step of depositing a first reflection layer on said first recording layer,
step of depositing an intermediate layer on said first reflection layer,
step of depositing a second recording layer capable of optical recording on said intermediate layer,
step of depositing a second reflection layer on said second recording layer, and
step of bonding said second reflection layer and a second substrate together,
wherein where a real part of complex refractive indexes of said first recording layer and said second recording layer is n, and an imaginary part of the complex refractive indexes is k, in the step of depositing said first recording layer, said first reflection layer, said second recording layer and said second reflection layer, a requirement of k≦0.125n−0.175, 2≦n≦3 is met.

11. The method for production of an optical recording medium according to claim 10,
wherein grooves are formed in a helical or centric form on said first substrate and said intermediate layer.

12. The method for production of an optical recording medium according to claim 10,
wherein said first substrate has first grooves on said first recording layer side, and
said intermediate layer has second grooves on said second recording layer side.

13. The method for production of an optical recording medium according to claim 10,
wherein said first recording layer has first grooves recessed toward said first substrate side,
said intermediate layer has second grooves recessed toward said first substrate side, and
a depth of the second grooves is larger than a depth of the first grooves.

14. An optical recording medium having a structure comprising at least a first substrate, a first recording layer capable of optical recording, a first reflection layer, an intermediate layer, a second recording layer capable of optical recording, a second reflection layer and a second substrate in this order from a side on which recording, reproducing or recording and reproducing laser light is applied,
wherein said first substrate has first grooves on said first recording layer side, and
said intermediate layer has second grooves on said second recording layer side.

15. The optical recording medium according to claim 14,
wherein said first reflection layer and said second reflection layer each have a flat face on said first substrate side.

16. The optical recording medium according to claim 14,
wherein said intermediate layer has a dielectric layer on the second grooves on said second recording layer side.

17. The optical recording medium according to claim 14,
wherein said intermediate layer is composed of an ultraviolet curing resin.

18. The optical recording medium according to claim 14,
wherein a shape of the first grooves of said first substrate and said first recording layer, and a shape of said second grooves of said intermediate layer and said second recording layer have same phase structures when seen from said first substrate side.

19. A method for production of an optical recording medium comprising,
step of forming a first groove on a first substrate,
step of depositing a first recording layer capable of optical recording on said first substrate on the first groove side,
step of depositing a first reflection layer on said first recording layer,
step of depositing an intermediate layer on said first reflection layer,
step of forming a second groove on said intermediate layer on a side on which said first reflection layer is not provided,
step of depositing a second recording layer capable of optical recording on said intermediate layer on the second groove side,
step of depositing a second reflection layer on said second recording layer, and
step of bonding said second reflection layer and a second substrate together.

20. The method for production of an optical recording medium according to claim 19,
wherein said first reflection layer and said second reflection layer each have a flat face on said first substrate side.

21. The method for production of an optical recording medium according to claim 19,
wherein said intermediate layer has a dielectric layer on the second grooves on said second recording layer side.

22. The method for production of an optical recording medium according to claim 19,
wherein said intermediate layer is composed of an ultraviolet curing resin.

23. The method for production of an optical recording medium according to claim 19,
wherein a shape of the first grooves of said first substrate and said first recording layer, and a shape of said second grooves of said intermediate layer and said second recording layer have same phase structures when seen from said first substrate side.

24. An optical recording medium having a structure comprising at least a first substrate, a first recording layer capable of optical recording, a first reflection layer, an intermediate layer, a second recording layer capable of optical recording, a second reflection layer and a second substrate in this order from a side on which recording, reproducing or recording and reproducing laser light is applied,
wherein said first recording layer has first grooves recessed toward said first substrate side,
said second recording layer has second grooves recessed toward said first substrate side, and
a depth of the second grooves is larger than a depth of the first grooves.

25. A method for production of an optical recording medium comprising,
step of forming grooves at a predetermined position on one face of a first substrate,
step of depositing a recording medium on said first substrate to form a first recording layer having first grooves having a shape following the grooves of said first substrate,
step of depositing a first reflection layer on said first recording layer,
step of depositing an intermediate layer on said first reflection layer,
step of forming grooves recessed toward said first substrate side on an opposite side of said intermediate layer,
step of depositing a recording medium on said intermediate layer to form a second recording layer having second grooves having a shape following the grooves of said intermediate layer,
step of depositing a second reflection layer on said second recording layer, and
step of depositing a second substrate on said second reflection layer,
wherein said second recording layer has the second grooves having a depth larger than a depth of the first grooves.
